(19) United States
(12) Patent Application Publication
(10) Pub. No.: US 2001/0054147 A1
(43) Pub. Date: Dec. 20, 2001

(54) Electronic identifier

(76) Inventor: Ernest S. Richards, Pottstown, PA (US)

Correspondence Address: Michael F. Petock, Esquire, 46 The Commons at Valley Forge, 1220 Valley Forge Road, Post Offuce Box 856, Valley Forge, PA, 19482-0856, US

(21) Appl. No.: 09/761,133

(22) Filed: Jan. 16, 2001

Related U.S. Application Data
(60) Provisional application No. 60/194,456, filed on Apr. 4, 2000.

(51) Int. Cl. H04L 9/00

(52) U.S. Cl. 713/172

(57) ABSTRACT

A method, apparatus and system for electronically verifying that a person using an electronic apparatus is who the person claims to be. It may be used for computers, e-commerce, financial transaction cards, automotive access and ignition, security badges, building access, cell phones and any other application in which electronic identification of a person is required. The security device in initiating a contact or in response to an inquiry as to identification transmits its public key identification number. The host encrypts a random message utilizing the user's public key identification number. Assuming the user is who the user claims to be, the user is able to decrypt the random message utilizing the user's corresponding private key. The private key never needs to be disclosed to anyone. The random message is changed with each use. The decrypted random message, which may preferably be a random number, is sent to the host, which upon favorable comparison with the random message sent to the user is able to verify that the user is the person he or she claims to be. All of this may be accomplished over unsecure lines without any requirement for a central controlling authority. The system may preferably be embodied in hardware which is detachable from any computer and transportable. However, it may be incorporated into software in a computer or the like.

### CROSS REFERENCES TO RELATED APPLICATIONS AND PATENTS

This application claims the benefit of U.S. Provisional Application No. 60/194,456, filed Apr. 4, 2000 by the Inventor herein, entitled “Electronic Identifier.”

### FIELD OF THE INVENTION

The present invention relates to a method, apparatus and system for electronically verifying that an electronic apparatus (and therefore the person using it) is who it and the user claim to be.

### BACKGROUND OF THE INVENTION

There is a need to securely and with certainty identify and verify that a party utilizing a piece of electronic equipment, such as a personal computer on the internet, is who he or she claims to be. For example, how does a user, who wants to use banking services over the internet, prove that he is who he claims to be. Passwords have many problems, they can be hacked, the master list can be compromised, the communications channels may be bugged, tapped or otherwise eavesdropped on, and the proliferation of passwords can cause passwords to be written down or forgotten. As soon as they are written down, they have a substantial risk of falling into the wrong hands. Keeping track of passwords, and particularly multiple passwords for multiple uses or applications is troublesome.

Electronic password devices continue to have security problems, being subject to bugging and the master lists being compromised. The same device, when used for multiple hosts, allows one host to possess the information needed to “log-on” to any other host using that device. Thus the existing devices are only as secure as the least secure host.

Even in biometrics, wherein biological characteristics of a person are measured and compared against their stored list of characteristics, such identification is not completely secure as the stored data and the measurement in the transmission path may not be secure thereby compromising the identification of the person. Again the system is only as secure as the least secure holder of the information.

### SUMMARY OF THE INVENTION

The present invention is a super security password system for computers, e-commerce, financial transaction cards such as credit cards and the like. Further, it may be used in numerous other applications including automotive access, automotive ignitions, security badges, national identity cards, building access, cell phones and the like.

Although the present invention may be implemented in software, it is preferably implemented by the use of hardware. Further, it is preferably implemented in the form of hardware which may be separable from a computer when not required for use. For example, in accordance with a preferred embodiment of the invention, the invention may be incorporated into a self contained electronic box, based on read only memory (ROM), technology, wherein the user connects the box temporarily to his personal computer or the like only when it is needed to be used.

In accordance with the present invention, the identification process is not based on shared information. In accordance with the present invention, identification is made possible by the use of an encrypted random message which must be returned in its unencrypted or decrypted form. The encryption is based on two key cryptography, sometimes referred to as public key cryptography. Simple operations may be performed on a challenge message from the host to the user to improve security.

In accordance with the present invention, an apparatus and method in accordance with the invention may be used as a universal identifier.

In accordance with the present invention, the user identification unit and system retain their security even over compromised communication channels and with a compromised host. If a user uses this system with a compromised host, the security of the user's identification with other hosts is not degraded.

In accordance with the present invention, the user verification is rapid, secure and invisible to the user enabling the host to authenticate the identity of the user repeatedly and frequently.

In accordance with the present invention, the user unit may preferably be a stand alone device in which all of the software is stored in write once program memory. This has the advantage of providing a fire wall against computer based snooping.

In accordance with the present invention, the identification unit may be built into various devices such as cell phones, company badges, national identity cards, fax machines, electronic check books and the like.

Further, in accordance with the present invention, data may be transferred into and out of user units by electrical connections, floppy drives, RF links, IR links, acoustical links or phone lines.

In accordance with the present invention, all of the user units have the same basic software, but different key pairs. Many user units may be programmed with the same key pairs to provide for multiple applications by the same person or for the eventuality of broken units.

In accordance with the present invention, no central controlling authority is required. The user may be given the opportunity to load his or her own key pair.

In accordance with the present invention, a user unit provides its public key (EN) to initially identify itself. That is when a host asks a user who it is, the user unit provides its public key to serve as a preliminary identification of the user unit (subject to verification), and may provide an account number.

Briefly and basically, in accordance with the present invention, a method, system and hardware are provided in which numerous users may be provided with a public key (EN) and a corresponding private key. Such users may have built in software, but preferably have detachable hardware connected to or associated with (i.e. by an infrared communication link) their personal computer or the like. These users may desire to communicate with various hosts. By using the system of the present invention, the host, such as a bank doing business over the internet, can identify with certainty that the communications coming from a user is the party who holds the public key listed and the corresponding private key, without in any way compromising the user's private key even though all communications are conducted over an unsecure communication channel.

In accordance with the present invention, described with respect to User A, which may be one of many users, the Host would query User A as to, “who are you.” User A would respond by sending the Host it's public key encryption number (ENA). The Host verifies that ENA is a valid public key number. The Host would then encrypt a random message, such as a random number, using the public key of User A (ENA) and send it (ENA(RM)) back to User A. User A then decrypts the encoded random message (ENA(RM)), using the never disclosed private key of the key pair, and sends the random message (RM) back to the Host. When the Host receives the random message (RM) which it sent to User A, properly decoded, the Host knows that User A is the party it claims to be, that is the person communicating with the Host holds the user unit A which holds both keys and has it attached to its computer for operation.

In using the system, the Host never uses the same message twice as the random message. In other words, the Host generates a new random message each time which it encrypts and sends back to the user using the user's public key encryption number. Since only the particular user, in this case User A, can decrypt the random message sent by the Host, the system is secure. There is no need for the sharing of any private keys in utilizing the system.

### BRIEF DESCRIPTION OF THE DRAWINGS

For the purpose of illustrating the invention, there are shown in the drawings forms which are presently preferred; it being understood, however, that this invention is not limited to the precise arrangements and instrumentalities shown.

FIGS. 1 through 5 comprise block diagrams illustrating the steps of an identification process between a user and a host.

FIG. 6 is a block diagram of a user system and host wherein the user system is provided with a separate User A hardware for attachment to the user's computer.

FIG. 7 is a block diagram of a general user unit incorporated in various applications and a general host.

FIG. 8 is a block diagram in somewhat more detail of the circuitry which may be utilized in carrying out the present invention.

### DETAILED DESCRIPTION OF THE PREFERRED EMBODIMENTS

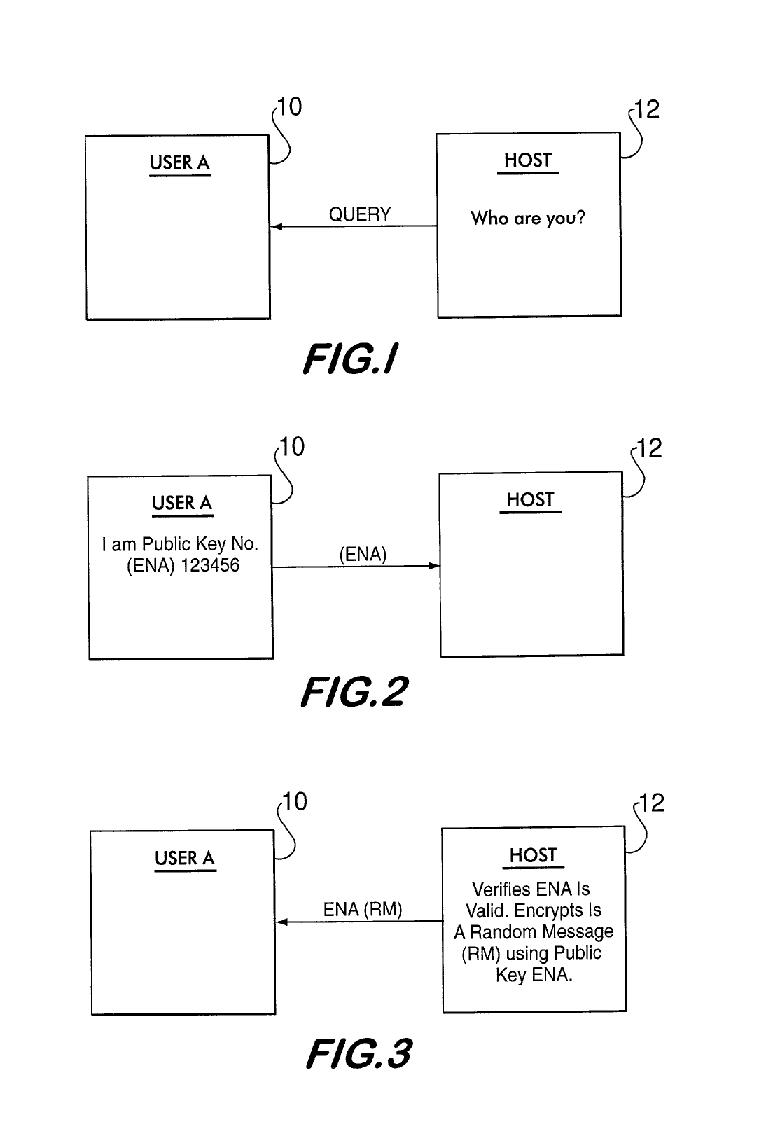

Referring now to the drawings, wherein like numerals indicate like elements, there is shown in FIGS. 1 through 5 a flow chart or series of functions utilized in identifying a particular user, User A 10 with a Host 12. Block 10 may also be considered to be a security device. Incorporated within security device 10 may be security hardware or security software. Preferably, the security hardware is detachable and/or separate therefrom, but in communication therewith either by hardwire, infrared or radio frequency link.

In use, User A may contact a host, such as a bank computer. Alternatively, a host may contact User A and ask it to identify itself. In any event, as shown in FIG. 1, the initial step in the identification process is for Host 12 to query the user as to “who are you?”

User A 10, as shown in FIG. 2, responds to Host 12 by transmitting to the host it's public key encryption number ENA, for example, 123456, although such encryption numbers are typically much larger.

As shown in FIG. 3, Host 12 verifies that the public key encryption number ENA is valid. That is, that it is contained on the list and remains subsisting on the list. It verifies that it has not been taken off the list because of some incident of compromise, non-payment or the like. The Host then encrypts a random message, such as a random number, using the public encryption key ENA of User A, and transmits the encrypted random message ENA (RM) back to User A.

As shown in FIG. 4, User A decrypts the message ENA (RM) and sends the unencrypted or decrypted random message (RM) back to Host 12.

As shown in FIG. 5, the Host receives back the random message (RM), such as a random number, that it has previously sent to User A in encrypted form, and determines or now knows that it is in fact communicating or dealing with the person who holds the electronic equipment with the private key for User A. In other words, the Host knows that it is dealing with User A. No other user could have decrypted the random message sent by the Host 12. Host 12 does not reuse the random message on other occasions in dealing with User A or in dealing with other users. It generates a new random message each time it tries to verify the identification of a user.

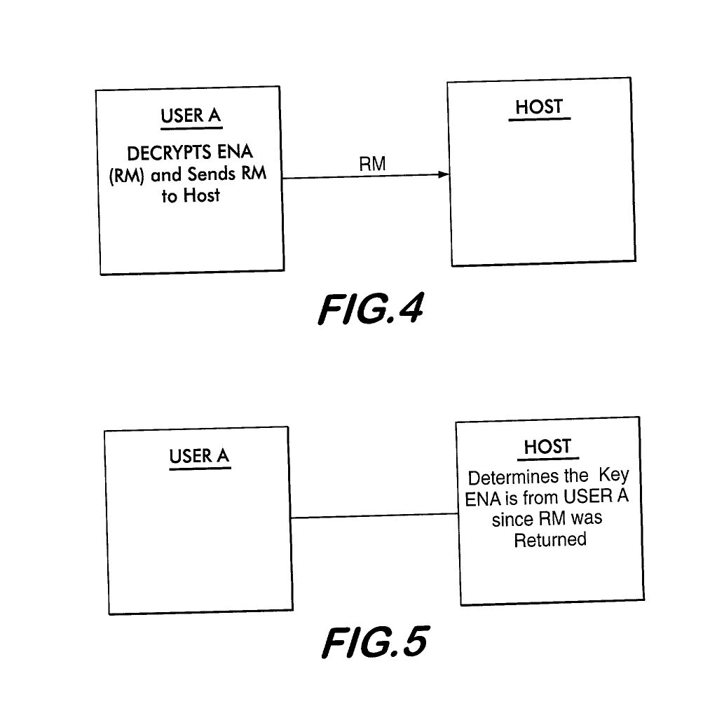

As shown in FIG. 6, preferably User or security device 10 is comprised of a personal computer or laptop computer 14 and separate User A security hardware 16 which is in communication with computer or laptop computer 14. The user A security hardware 16 may be an electronic box which communicates with the computer either through hard wire electrical connection, RF link, IR link, acoustical link or the like. The User A security hardware 16 has its private key physically installed in it, preferably by means of a read only memory (ROM), semiconductor chip or one time programmable microprocessor. The one time programmable processor would be provided with a “don't allow program read out bit” which would be set to prevent reading out of the private key. The read only memory of one time programmable microprocessor or semiconductor chip would not “forget” or loose its private key when it looses power.

Alternatively, but not preferred, the user unit 16 could be contained within computer 14 and could even be placed in the software of computer 14. However, this would have the disadvantage of the possibility of being compromised by hackers or the like and the disadvantage of loss by hard disk failure.

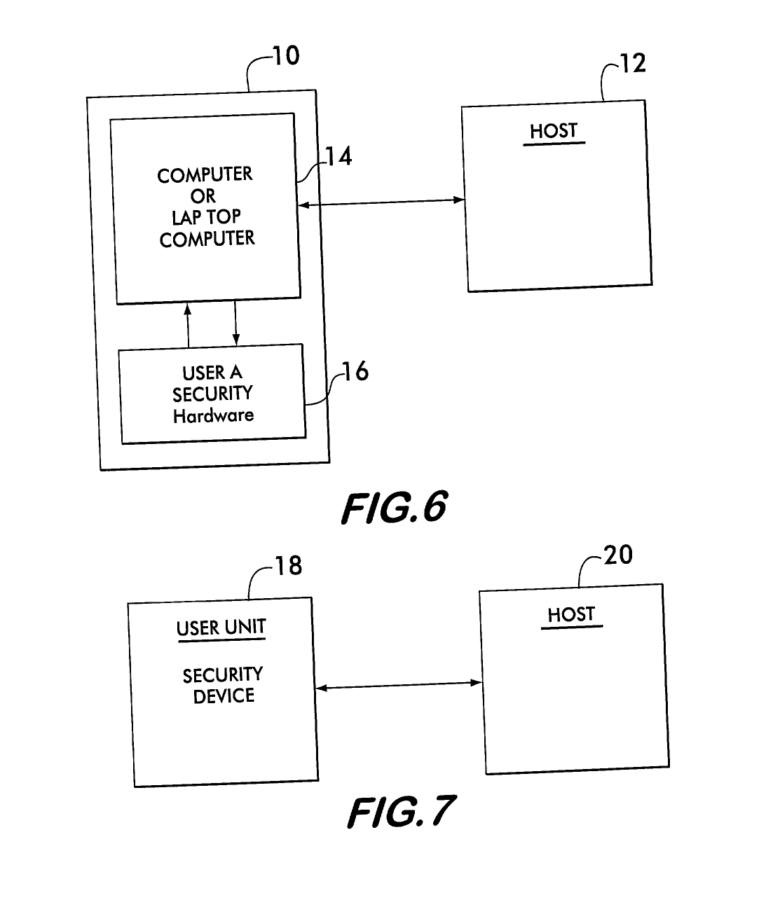

Although the arrangement of FIG. 6 is a preferred embodiment for use in communicating between various users and various hosts on networks, such as the internet, the system described herein may be used in various other applications including automotive access, automotive ignitions, access to buildings, security badges, national identity cards, credit cards, and any other applications where positive and secure identification of a person is necessary. For example, as shown in FIG. 7, the user unit security device 18 may be incorporated in a car key, badge, credit card or other access unit and the Host 20 may be the corresponding one of these, for example, Host 20 may be an automobile door lock, automobile ignition system, an entry sensor for checking security badges, a sensor at a merchant's check out counter or an electronic controlled door lock.

User unit security device 18 would be a self contained unit containing all of the necessary hardware or software, including that used for permanent storage of a corresponding public key number and private key number, circuitry for carrying out encryption and decryption, such as by the RSA algorithm or cryptosystem (originated by R. L. Rivest, A. Shamir and L. Adelman) and the ability to communicate with the host by any suitable means, including, but not limited to, direct connections such as plug-in jack, radio frequency link, infrared link, acoustical link, magnetic link or any other suitable means of communication. Host 20 would of course include means for generating a random message, such as a random number, means for encryption of the random number using the public key number received from user unit security device 18, means for storing the random number generated until a response to reply is received from user under security device 18 and means for comparing the stored random message with the random message received back from user unit security device 18 after decryption. Any suitable means may also be utilized by the host including the RSA algorithm, so long as it is compatible with the encryption method used by user unit security device 18. Host 20 may also include means for enabling or sending a signal to enable a particular action in a particular case, whether it is setting up further communication, opening a door such as a car door or a security area door, enabling an automobile ignition, a sensor at a merchant's check-out counter or any other suitable application.

In accordance with this invention, only one pair of keys is needed for each user. In other words, once a user possesses the public key and has the corresponding private key, this pair of keys may be utilized with all hosts. Further, this pair of keys may be used in various applications. In other words, the same pair of keys may be utilized on the user's computer for e-mail and communications such as banking via the internet, car access, car ignition, access to secure spaces and the like. There is no need for any passwords to be remembered or stored. Any host or acceptor can guarantee or be sure that it has identified the party holding the user unit or token for the specified public key encryption number (EN). When a user goes to a new vendor with his public name and public encryption number, it allows the user instant access and acceptance. No waiting periods, no call backs, and no mail backs.

In accordance with this invention, since the user verification is rapid, secure and invisible to the user, the host may authenticate the identity of the user repeatedly and frequently. This is very different from prior art systems in which the identity of the user is verified only upon entry. The present invention enables the host to compartmentalize its information which lessens the damage an intruder can do. Effective and efficient data compartmentalization limiting access to data compartments by certain users after they have initially “logged-on” is made feasible by this invention's ability to provide repeated and frequent verifications which are invisible to the user. In other words, the identity of the user is verified at log-on to the host and may require additional verification when each new data compartment is attempted to be entered, allowing selective access to data within the host. Further, as indicated above, repeated and frequent verifications may be made at preset intervals or random intervals. An intrusion may still be possible if an attacker has all of the information that passes between the host and the user's computer. The attacker may stop the legitimate users sign off and take over the still open channel. Compartmentalization with repeated and frequent verifications invisible to the user limits the access of such an attacker.

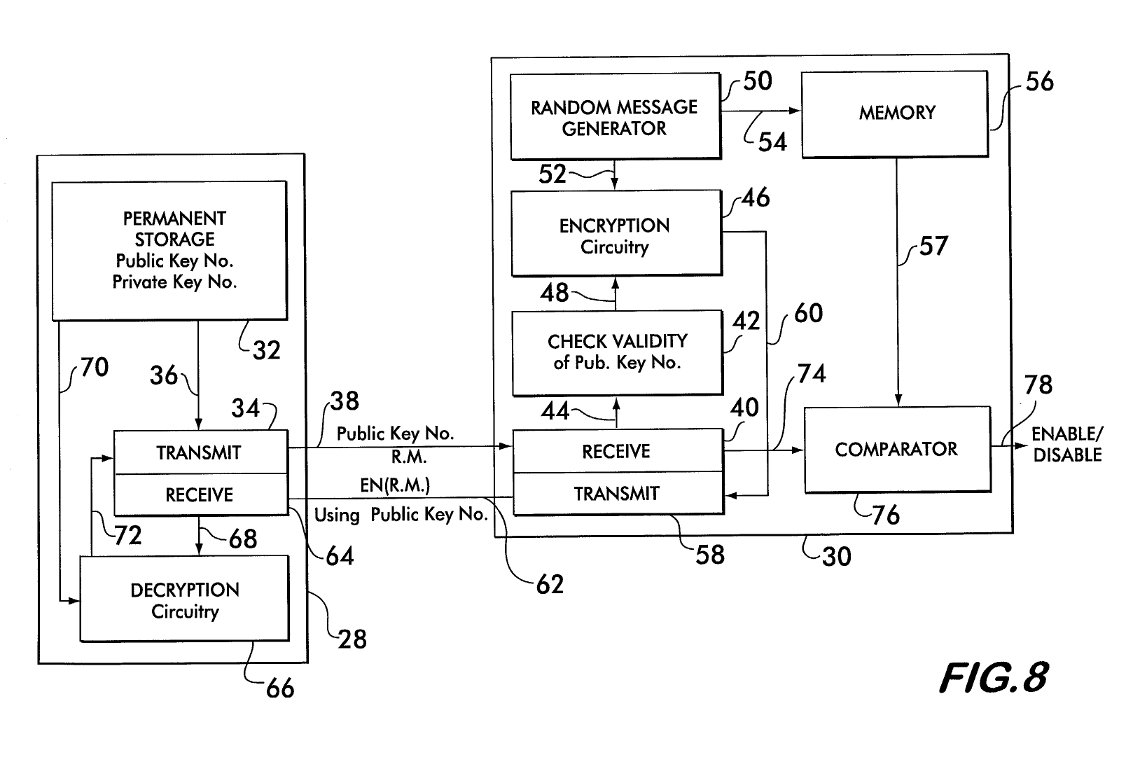

Referring now to FIG. 8, there is shown a block diagram of circuitry which may be utilized in carrying out the present invention.

Security device block 28 may correspond to block 18 or block 10. Block 30 may correspond to host 12 or 20. The substantial difference between FIGS. 6 and 7 is that the transmit and receive circuitry in FIG. 6 may be the modem or other communication device located in the computer or laptop computer 14 in FIG. 6, whereas in FIG. 7 it would be a self contained unit.

Referring now more particularly to FIG. 8, there would be permanent storage 32, which as described previously, may be a read only memory, a one time programmable microprocessor, a semiconductor chip or any other suitable permanent memory. Permanent storage 32 would store, inter alia, the corresponding public key number and private key number. Permanent storage 32 may also be used to store various other information such as account numbers either in permanent storage or in a sub memory which is programmable so that account numbers may be changed. However, the identity of the person's public key number and private key number never changes. As discussed above, when a user wants to communicate with the host or if the host queried the user for identification, the public key number would be retrieved from memory 32 and sent to transmitter 34 via line 36. It is understood throughout that the reference to line herein in the block diagrams may comprise a plurality of lines or a bus as is common in this art, or other suitable channel of communication. Transmitter 34 would transmit the public key number, unencrypted, via line 38 to receiver 40 in host 30. It is understood that line 38, as well as line 62 to be discussed hereinafter, may be various types of communication links including infrared, radio frequency, sonic or the like. In some instances, the links could include satellite transmission links. Any form of communication between the user and the host may be utilized.

Receiver 40 in host 30 would send the public key number to unit 42 via line 44. Unit 42 would check that the public key number is a valid subsisting public key number. This may be done by communication with a remote database or by storage of all currently assigned public key numbers in a database located at the host. Assuming that the public key number is a valid, subsisting valid public key number, the public key number would be sent to encryption circuitry 46 via line 48. Encryption circuitry 46 receives a random message, preferably a random number, from random message generator 50 via line 52. This same random message or random number is sent via line 54 to memory 56 for storage for later use when a response is received from the user 28. Encryption circuitry 46 may use the RSA algorithm or any other suitable encryption method to encrypt the random message. The encrypted random message is sent to transmitter 58 via line 60.

Transmitter 58 sends the encrypted random message using the public key number of the user via line 62 to receiver 64 located in user security device 28. Receiver 64 sends the encrypted random message to decryption circuitry 66 via line 68. Decryption circuitry 66 receives via line 70 the private key number stored in permanent storage 32. Assuming the user is the person he or she claims to be, decryption circuitry 66 is able to decrypt the encrypted random message received from host 30. The decrypted random message is sent via line 72 to transmitter 34 which transmits it via line 38 to receiver 40 located at host 30.

Receiver 40 provides the decrypted random message via line 74 to comparator 76 which compares it with the random message previous stored in memory 56, received via line 57. Assuming the random message received matches the random message stored in memory 56, an enable signal is produced at 78 as the output of comparator 76. This may enable various functions as desired by the host, such as enabling a financial transaction, opening a lock or any other suitable function which should be enabled upon proper identification of a person.

As discussed above, the apparatus of the present invention may be used not only at the time that a user logs on to a host, but repeatedly and frequently during the time that a user is connected to the host (a session). As discussed above, this enables effective and efficient data compartmentalization limiting access to data compartments by certain users. In other words, each data compartment may be limited to access by certain users. Since the present invention enables repeated and frequent verifications which are invisible to the user, this enables control of various data compartments within the host without burdening the user. As discussed above, not only are the repeated and frequent verifications useful for controlling access to different data compartments, but may also be used at various intervals during use within any particular compartment, and these may be at preset time intervals or random time intervals.

It will be apparent to those skilled in the art that other variations of circuitry may be utilized to achieve the goals of the present invention within the spirit of the present invention.

In view of the above, the present invention may be embodied in other specific forms without departing from the spirit or essential attributes within the scope of the invention.

I claim:

1. A method of electronically verifying that a person possessing a security device is who the person claims to be, comprising:
sending a message by said security device associated with the person whose identity is to be verified, said message including said person's public key number;
receiving said message by a host, said host encrypting a random message using said public key number and sending said public key number encrypted message to said security device;
said security device decrypting said public key number encrypted random message using said person's private key number and sending said decrypted random message to said host; and
said host comparing the decrypted random message sent by the security device with the random message previously encrypted by said host with said public key number to verify the identity of the person.

2. A method in accordance with claim 1 wherein said security device is a computer with associated security hardware having said person's private key number programmed therein.

3. A method in accordance with claim 1 wherein said security device is a laptop computer with associated security hardware having said person's private key number programmed therein.

4. A method in accordance with claim 2 wherein said security hardware includes a one time programmable macroprocessor.

5. A method in accordance with claim 3 wherein said security hardware includes a one time programmable microprocessor.

6. A method in accordance with claim 2 wherein said security hardware includes a read only memory for storing said person's private key number.

7. A method in accordance with claim 3 wherein said security hardware includes a read only memory for storing said person's private key number.

8. A method in accordance with claim 1 wherein said security device is a computer provided with associated security software having said person's private key number programmed therein.

9. A method in accordance with claim 1 wherein said security device is a laptop computer provided with associated security software having said person's private key number programmed therein.

10. A method in accordance with claim 2 wherein said security hardware is insertable and removable in a drive of said computer.

11. A method in accordance with claim 3 wherein said security hardware is insertable and removable in a drive of said laptop computer.

12. A method in accordance with claim 1 wherein said security device is a badge or identification card with associated security hardware having said person's private key number programmed therein.

13. A method in accordance with claim 1 wherein said security device is a car key with associated security hardware having said person's private key number programmed therein.

14. A method in accordance with claim 2 wherein said security hardware communicates with a computer by an infrared link.

15. A method in accordance with claim 2 wherein said security hardware communicates with a computer by a radio frequency link.

16. A method in accordance with claim 3 wherein said security hardware communicates with a laptop computer by an infrared link.

17. A method in accordance with claim 3 wherein said security hardware communicates with a laptop computer by a radio frequency link.

18. A method in accordance with claim 1 wherein said host first sends a query to said security device as to its identity before said security device sends a message which includes said person's public key number.

19. A method in accordance with claim 1 wherein the method of electronically verifying is repeated during a session on which said security device is logged-on to said host.

20. A method in accordance with claim 19 wherein said repeated verification is invisible to said person possessing said security device.

21. A method in accordance with claim 19 wherein said host compartmentalizes data requiring a verification for each data compartment.

22. Apparatus for enabling electronic identification of a person, comprising:
means for permanently storing a corresponding private key number and a public key number assigned to said person;
means for sending said public key number to a host seeking to verify the identity of said person;
means for receiving from said host a random message encrypted with said public key number;
means for decrypting said random message encrypted with said public key number; and
means for sending said decrypted random message to said host for comparison to said random message previously encrypted with said public key number to verify the identity of said person.

23. Apparatus in accordance with claim 22 including means at said host for generating a random message.

24. Apparatus in accordance with claim 23 including means at said host for encrypting said random message.

25. Apparatus in accordance with claim 23 wherein said random message is a random number.

26. Apparatus in accordance with claim 24 wherein said means at said host for encrypting includes use of the RSA algorithm.

27. Apparatus in accordance with claim 22 wherein said means for decrypting said random message includes use of the RSA algorithm.

28. Apparatus in accordance with claim 22 wherein said means for permanently storing is comprised of a one time programmable microprocessor.

29. Apparatus is accordance with claim 22 wherein said means for permanently storing comprises a read only memory.

30. Apparatus in accordance with claim 22 wherein said apparatus is contained on security hardware which communicates with a computer.

31. Apparatus in accordance with claim 22 wherein said computer is a laptop computer.

32. Apparatus in accordance with claim 30 wherein said security hardware communicates with said computer by an infrared link.

33. Apparatus in accordance with claim 30 wherein said security hardware communicates with said computer by a radio frequency link.

34. Apparatus in accordance with claim 22 wherein said apparatus is mounted on a badge.

35. Apparatus in accordance with claim 22 wherein said apparatus is mounted on a card for use as a car key.

36. Apparatus in accordance with claim 22 wherein said apparatus is mounted on a card for use as a financial transaction card.

37. Apparatus in accordance with claim 22 wherein said apparatus is mounted on an identification card.
